(19) United States
(12) Patent Application Publication
(10) Pub. No.: US 2004/0064461 A1
(43) Pub. Date: Apr. 1, 2004

(54) Method and arrangement for dynamic detection of SCSI devices on linux host

(76) Inventors: Subramaniyam Pooni, Ventura, CA (US); Rajkumar Mangalore, Bangalore (IN); Vijay Srinath, Bangalore (IN); Vikram Krishnamurthy, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/260,419

(22) Filed: Oct. 1, 2002

(51) Int. Cl. G06F 17/00

(52) U.S. Cl. 707/100

(57) ABSTRACT

The method and arrangement are utilized in order to dynamically detect one or more SCSI devices on a Linux host. The method includes issuing a first command to return an actual number of host that are currently installed in a Linux system, and a maximum number of buses and targets supported by the Linux system. To all hosts, buses and targets returned in response to the first command, a second command is issued, but is issued only to a logical unit number zero (lun(0)) of each returned target. The second command prompts each responding lun (0) to report all luns known to the target. For each reported lun, a new device structure is created, in real time, with each new device structure representing a detected SCSI device.

### BACKGROUND

In a Linux or UNIX operating system (OS), everything that accepts or sends data to or from the OS is considered to be a “device”. Common devices include terminals, hard disks, printers, CD drives, and modems. Each of these devices may also be SCSI devices. SCSI (small computer system interface) is a family of standards that connects components via a parallel bus for system-level interfacing between a computer and intelligent devices such as hard disks, floppy disks, CD ROMs, printers, scanners and other types of media devices or storage devices. SCSI protocol can connect multiple devices to a single adaptor (e.g., a host bus adapter (HBA) or port) on a SCSI bus. SCSI devices transfer bits in parallel and can operate in either asynchronous or synchronous modes.

A device driver is a software module that is part of the kernel and that supports access to a peripheral device. A device driver is a collection of subroutines and data within a kernel (a kernel is the core software of an OS) that constitutes the software interface to an I/O device. In Linux, when a device needs to be accessed the Linux kernel passes an I/O request to the device driver, which handles the communication with the device. Special device files (hereafter “device files”) are used to access devices which are connected to a Linux system, devices such as printers, tape drives, terminals and disk drives used for file system storage. Device files are kept in what is called a /dev directory and are given device file names representative of their function, such as “/dev/fd0” for a floppy drive, for example. A device file may be type c (for “character” devices, devices that do not use a buffer cache) or type b (for “block” devices, which go through a buffer cache). In Linux, all disks are represented as block devices only.

Device numbers allow the operating system to differentiate between the devices. In a standard Linux implementation, each device is assigned a major number and a minor number. The major number identifies the driver, while the minor number identifies the instance of the device. For example, the device file name “/dev/fd0” identifies the first floppy drive on a system, with “fd” representing the major number, and “0” representing the minor number of the device file name.

In a storage system such as a storage area network (SAN), a user application keeps track of what hosts and devices are part of the SAN at any point in time. For example, this application needs to know what devices have been added and deleted. Standard Linux currently has a limited capability to dynamically detect (add or delete) devices, where Linux can only dynamically (in real time) add or delete a single SCSI device However, before delving into the problems with adding and deleting SCSI devices to Linux hosts, an overview of the driver architecture and addressing in the Linux SCSI I/O Subsystem is provided in order to provide further context.

Driver Architecture Overview

FIG. 1 illustrates a driver architecture for the Linux SCSI I/O Subsystem. A Device driver is a software module that is part of the kernel and that supports access to a peripheral device. A device driver is a collection of subroutines and data within the kernel that constitutes the software interface to an I/O device. For example, in a Linux OS, when a device needs to be accessed, the Linux kernel passes the I/O request to the device driver, which handles the communication with the device. Special device files are used to access the devices which are connected to a Linux system such as printers, tape drives, terminals and disk drives that are used to store file systems. Special device files (hereafter device files) are kept in what is called a /dev directory and are given device file names representative of their function, such as “/dev/fd0” for a floppy drive, for example.

Often, there is more than one of a particular type of device on a system. Devices are identified by a device number. Device numbers allow the operating system to differentiate between the devices. In a standard Linux implementation, each device is assigned a major number and a minor number. The major number identifies the type of the device (really the device driver) while the minor number represents an instance of a device of the type specified by the major device number. The major number in Linux is a number ranging from 0 to 255 that identifies the device type. The minor number is also a number ranging from 0 to 255 which specifies a specific device among a group of devices that share the major number. For example, the device file name “/dev/fd0” identifies the first floppy drive on a system, with “fd” representing the major number, and “0” representing the minor number of the device file name.

The Linux SCSI I/O subsystem (hereinafter SCSI subsystem) has a three (3) level driver architecture with the “upper” level layer 100 being closest to a user space/kernel space interface 110, while the “lower” level layer 150 is closest to hardware (e.g., physical SCSI device, not shown). The upper level drivers (ULDs) in upper level 100 are commonly known by a terse two letter abbreviation (e.g. “sd” for SCSI disk driver, “st” for SCSI tape driver, “sr” for SCSI CD-ROM driver; and “sg” for a SCSI generic driver). The names of the corresponding module drivers which, for historical reasons, sometimes differ from the built-in driver names are shown in brackets in FIG. 1.

The ULDs in upper level layer 100 maintain the kernel side of the Linux OS's user-kernel interface for the logical class of devices they represent (e.g. disks). They are also responsible for managing certain kernel and SCSI subsystem resources such as kernel memory and SCSI command structures. Applications in the user space can access any device connected to the linux hosts using these ULDs by opening a device file (block or char) typically found in the /dev directory tree.

Accordingly, the upper level layer 100 supports the kernel/user interface. For example, in the case of sd (disk) drivers and sr (CD-ROM) drivers, the kernel/user interface is a block device interface, while for st (tape) drivers and sg (generic) drivers, the kernel/user interface is a character device interface. Devices can be classified as being either “character mode” or “block mode”. Terminals, printers, and modems are character devices since they handle data one character at a time. Hard drives and tape drives use blocks to transmit data as large chunks of information so they are block mode devices. Some devices function in either mode using two different device drivers.

The mid-level SCSI layer 125 is common to all operations. The midlevel SCSI layer 125 defines internal interfaces and provides common services to the upper and lower level drivers. IOCTLs (input/output control commands) provided by the mid-level SCSI 125 layer are available to file descriptors belonging to any of the four ULDs (sd, sr, st, sg device drivers). Any operation using the SCSI subsystem (e.g. reading a sector from a disk) involves one driver at each of the 3 levels, e.g. sd drivers at upper level 100, SCSI mid-level driver at SCSI mid level layer 125 and an HBA driver of lower level layer 150.

SCSI subsystem Addressing.

Linux has a four level hierarchical addressing scheme for SCSI devices: (a) SCSI adapter number [host]; (b) channel number [bus]; (c) ID number [target]; and (d) LUN [lun]. The term “LUN” is a common SCSI abbreviation of Logical Unit Number. The LUN identifies the logical unit within a SCSI target device. A SCSI target device is a SCSI device containing logical units (LUs) that service commands from a SCSI initiator device in order to carry out a specified task for example. As is known, a logical unit may be defined as addressable blocks of storage created from one or more disks (also called spindles) contained within a SCSI device. A logical unit may provide a unique connection to an application program or another SCSI device. “Bus” is used herein in preference to “channel” in the description below.

The SCSI adapter number is typically an arbitrary numbering of adapter cards on internal I/O SCSI buses (e.g. PCI, PCMCIA, ISA, etc.) of a computer (Linux host) running the Linux OS. Such adapters are commonly referred to as host bus adapters (HBAs). HBA numbers are issued by the Linux kernel in ascending order, starting with 0 and proceeding for N HBAs. Each HBA may control one of more SCSI buses.

Each SCSI bus can have multiple SCSI devices connected to it. In SCSI parlance, the HBA may be called the “initiator” (e.g., it may be an HBA of a SCSI initiator device) and takes up one SCSI ID number (typically the number “7”). The initiator talks to targets, commonly also known as SCSI target devices (e.g. disks), as briefly discussed above.

On SCSI parallel buses, the number of SCSI IDs are related to the width of the bus. For example, 8-bit buses (sometimes called “narrow” SCSI buses) may have 8 SCSI IDs, of which one ID is taken by the HBA, leaving 7 IDs for SCSI devices. Wide SCSI buses are 16 bits wide and can have a maximum of 15 SCSI devices (e.g., targets) attached. The SCSI-3 draft standard allows a large number of IDs to be present on a SCSI bus, (0-255) with each SCSI device adapted to contain multiple (LUNs). These multiple LUNs are typically used by sophisticated tape and CD-ROM units that support multiple media. Accordingly, Linux's flavor of SCSI addressing is a four level hierarchy: <scsi(_adapter_number), channel, id, lun>, which is most commonly known and denoted with <host, bus, target, lun>encoding, i.e., (h0b0t010). Thus, a path from a SCSI host to a SCSI device, or to a logical unit represented by a LUN on a SCSI device, can be determined from the <host, bus, target, lun>or (h, b, t, l) address of a logical unit.

Storage area networking is predicated on the replacement of parallel SCSI transport with networked storage SCSI devices and tape SCSI devices behind the server or Linux Host. The vast majority of storage area networks (SANs) use a Fibre Channel (FC) medium for the underlying network transport and, at the upper layer, move data to and from disks with serial SCSI protocol, as described in the current draft SCSI Primary Commands-3 (SPC-3) document. The latest version of the SPC-3 document, found at ftp://ftp.t10.org/t10/drafts/spc3/spc3r09.pdf, provides SCSI primary command standards that are designed to be used industry wide. The combination of a high-speed transport (FC) with native SCSI protocol results in an efficient means to deploy servers, disk arrays, and tape subsystems and frees all components from the constraints of parallel SCSI architecture.

The SCSI-3 device driver supplied by the HBA vendor is responsible for mapping FC storage resources to the bus, target, lun conventions required by Linux. Since FC addresses are self-configuring, the mapping between port addresses, (which may change) and the upper level SCSI device driver designations are maintained by the HBA and the HBA's device driver interface to Linux.

The driver architecture and addressing within the SCSI Subsystem having been introduced, a problem with adding (deleting) SCSI devices to a Linux host is now described. Currently, standard Linux has a limited capability of dynamically detecting (adding or deleting) a single SCSI device. This is done from the user space by using what is called a /proc file system. The file system /proc is a pseudo-file system that is used as an interface to kernel data structure. The /proc file system in Linux allows for the dynamic creation of nodes, enabling user modules to create entry points for easy information retrieval. The files and directories contained within the /proc pseudo-file system represent every piece of hardware, chipset, meg of RAM, and process that the Linux system is running. A file “/proc/scsi/scsi” is a file which is a listing of all SCSI devices known to the kernel. An echo <‘scsi add-single-device 1 0 5 0’>/proc/scsi/scsi (where 1 0 5 0 represent the <host, bus (channel), target (SCSI id), lun>address of a SCSI device) will cause a host (scsi 1) to scan on a SCSI channel 0 for a device on ID 5 LUN 0. If there is already a device known on this address or the address is invalid an error will be returned.

Standard Linux also does not provide a way to dynamically detect multiple devices which have been added or removed from the SAN. A reason behind this limitation is that, even if an HBA driver (low level driver) is able to recognize the addition or deletion of a device, the Linux OS on the Linux host does not recognize the newly discovered devices, as the Linux kernel (e.g., the kernel is the core or main software of the Linux OS) does not have a rescan mechanism in place. In Linux, every time a device is added or deleted, a scan by the Linux host of the SCSI bus must be performed. Conventionally, this has been done by re-booting the Linux host. Moreover even if there were a rescan mechanism is in place, there is no application in the user space to periodically, or on a need basis, trigger a rescan to dynamically detect newly discovered devices.

Linux has a limited capability of detecting newly added devices without a reboot for two further reasons. Firstly, a vector array in Linux, which holds scsi_device pointers (SDPs) to SCSI disk devices in the ULDs, is allocated at boot time in the Linux OS. A SDP is a pointer to a scsi_device data structure. A scsi_device data structure uniquely describes a path (e.g., h,b,t,l) to a SCSI device or LUN (logical unit). The size of this vector array, called a vector rscsi_disks array is fixed to be equal to the number of devices noticed during boot time, plus a small limited number of spare entries for newly added devices (for example, any device that is hot-plugged to the Linux host. Hence hot-plugging can be done for very few devices.

Secondly, only a single device can be added to the Linux host at a time. This can be done using an “add-single-device” command, which is executed from the user mode space. This command needs to be executed from user mode (e.g., command is passed from a user application such as a user daemon). The format is illustrated in the following example:

Example: scsi add-single-device a b c d″>/proc/scsi/scsi where

a=hostadapter id (first id being scsi0)

b=SCSI channel on hostadapter (first one being bus0)

c=ID (beginning with id0)

d=LUN (first LUN being LUN0)

An echo ‘scsi singledevice a b c d’>/proc/scsi/scsi will cause host “a” to scan on SCSI channel “b” for a device on ID “c” LUN “d”. If there is already a device known on this address or the address is invalid an error will be returned.

The command gets passed to the mid-level SCSI driver through the midlevel scsi's /proc interface. The mid-level SCSI driver probes the h,b,t,l, path to see if there is a SCSI device present. It first sends a TEST_UNIT_READY (TUR) command followed by an inquiry command. If a SCSI device is present, the mid-level SCSI driver creates an SDP and calls the attach ( ) routine of the ULDs). The attach( ) routine of the ULDs is called to insert the SDP pointing to the SCSI device 112 into the internal tables maintained by the ULD (device drivers). The index of location in which the SDP is inserted in the ULD's table becomes the minor number of a device file that corresponds to the device.

In order to perform a rescan of the entire SCSI bus, a user application needs to execute the add-single-device command for all possible values of host, bus, target and lun values to recognize all new SCSI devices that have been attached to the SCSI bus. The algorithm (“rescan algorithm”) for the steps that need to be performed in the user mode application to complete a rescan of the SCSI bus is given below.

For all SCSI host bus adapters, from scsi0 through scsiN

For all SCSI bus, from bus0 through bus255 on this host adapter

For all SCSI IDs on this bus, (e.g., id0 through id255 on this
bus)

For all Lun on this target (e.g., lun0 through lun255 on this
tgt)

Do add-single-device

End Lun-Loop

End-Target Loop

End-Bus Loop

End-Adapter Loop

This rescan, which uses the add-single-device command, is ineffective and inefficient because the vector size being allocated in the ULDs at boot time in order to hold SDPs pertaining to newly detected SCSI devices is limited to a fixed number of spare entries as described above. Assuming that the size of the vector may somehow be changed (increased), the current Linux device file limitation limits the Linux host's addressing capability to no more than 128 disk devices or 255 generic devices. Accordingly, no further device files can be created for newly discovered devices. In other words, if there are greater than 128 disk devices (or greater than 255 generic devices) that are to be added to the Linux host on a network such as a SAN, these additional devices will not be seen at all by the Linux host.

Further, if a scenario is envisioned where the device file limitation can be overcome, the iterative looping process of the rescan algorithm (for all possible h, b, t, l combinations) may take an inordinate amount of time. The looping process could conceivably be repeated on the order of several hundred factorial for SCSI devices that timeout or that don't respond properly (e.g., it could take a very long time until the Linux host realizes that a SCSI device is missing).

### SUMMARY OF THE INVENTION

A method and arrangement for dynamically detecting one or more SCSI devices on a Linux host is described. The method includes issuing a first command to return an actual number of hosts that are currently installed in a Linux system, and a maximum number of buses and targets supported by the Linux system. To all hosts, buses and targets returned in response to the first command, a second command is issued, but is issued only to a logical unit number zero (lun(0)) of each returned target. The second command prompts each responding lun (0) to report all luns known to the target. For each reported lun, a new device structure is created, in real time, with each new device structure representing a detected SCSI device.

### BRIEF DESCRIPTION OF THE DRAWINGS

The present invention will become more fully understood from the detailed description given here and below and the accompanying drawings which are given by way of illustration only, and thus are not limitative of the present invention, and wherein:

FIG. 1 illustrates a driver architecture for the Linux SCSI I/O Subsystem;

FIG. 2 depicts a diagram of an exemplary system 200 of SCSI devices in accordance with an embodiment of the invention; and

FIG. 3 is a sequence diagram according to unified modeling language (UML) principles illustrating a method and arrangement of dynamically detecting multiple SCSI devices on a Linux host in accordance with an exemplary embodiment of the invention.

FIG. 3 is a UML sequence drawing. Messages are depicted with arrows of different styles. A [symbol] indicates a synchronous message that expects a response. A [symbol] indicates a response message. A [symbol] indicates a message for which the response is implied. And a [symbol] indicates an asynchronous message for which no response is expected.

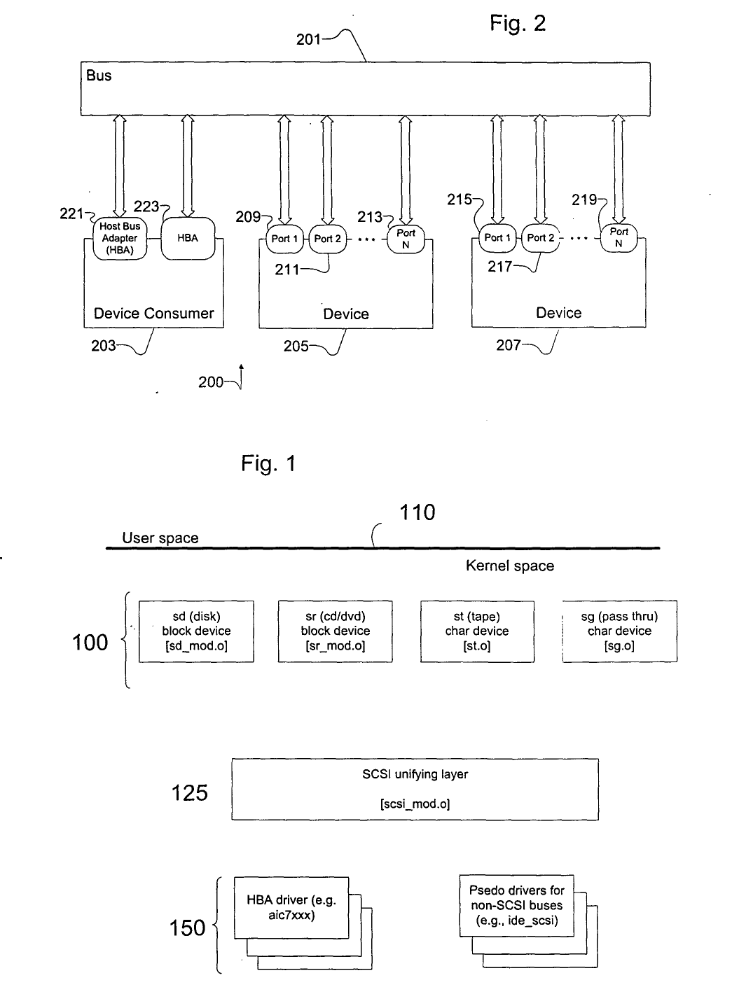

### DETAILED DESCRIPTION

In an exemplary embodiment, a kernel component is inserted into a SCSI subsystem in order to determine all valid h, b, t, l addresses of devices that are connected to the system. A user mode daemon initiates a rescan algorithm from user space for an actual number hosts installed on the system, max buses and targets supported by the system, and for lun(0), lun(0) being the target device lun. If a target device is present at that (h, b, t, l(0)) an SCSI inquiry command is sent to the target device (lun(0) by a mid-level SCSI layer of the SCSI Subsystem. The mid-level SCSI creates a scsi_device structure for the target device (lun(0)) and normally would call the upper level drivers (ULDs) attach( ) routine, providing an SDP pointing to the scsi_device structure as a parameter.

However, the kernel component, which may be embodied as a filter driver (which is also a type of ULD) has, in advance, swapped detect, attach and finish entry points of the ULDs with its own routines; thus the filter driver's attach routine gets called. The filter driver then sends a “REPORT_LUNS” SCSI command to that (h, b, t, l(0)).

Based on a response from the REPORT_LUNs command, the filter driver ascertains the number of LUNs on that specific lun(0) target device. The filter then creates as many scsi_device structures as there are LUNs on the target device, and copies most of fields from the scsi_device structure of lun(0) to the newly created scsi_device structures.

In the standard Linux implementation, this scsi_device structure is normally only created at boot time. However, in accordance with an exemplary embodiment as is to be described in further detail hereafter, once the structure is created, the attach routine of the ULDs is called and a SCSI device is accessible dynamically (e.g., in real time) from a user application running in user space by opening the corresponding device file.

FIG. 2 depicts a diagram of an exemplary system 200 of SCSI devices in accordance with an embodiment of the invention. The system 200 includes a bus (e.g., SCSI bus, fibre channel (FC), etc.) 201 to which are connected a consumer of device services (hereafter a device consumer) 203, a device 205 and a device 207. Device consumer 203 may be embodied as a computer that is running the Linux OS in system 200 (hence “Linux host”, and may also be referred to as a SCSI initiator device, and devices 205 and 207 may be referred to as SCSI target devices.

The device consumer 203 includes host bus adapters (HBAs) 223 and 223 that permit the device consumer 203 to connect to and interact with the bus 201. The device 205 has port 1 (209), port 2 (211), . . . port N (213). Device 207 has port 1 (215), port 2 (217), . . . port N (219). For simplicity of disclosure, only two devices 205 and 207 and two HBA's 221 and 223 have been depicted, but fewer or greater devices could be attached to the bus depending upon the particular circumstances of a situation.

System 200 could be embodied as a storage area network (SAN) for example. In a SAN, a storage area management (SAM) application, which may be an application that is run from user space (e.g., by a user or by a user daemon) keeps track of the exact set of hosts and devices that are part of the SAN at any point in time. All this means is that the SAM application needs to know when new SCSI devices are added are deleted from the Linux host, without requiring the necessity of a reboot of the host.

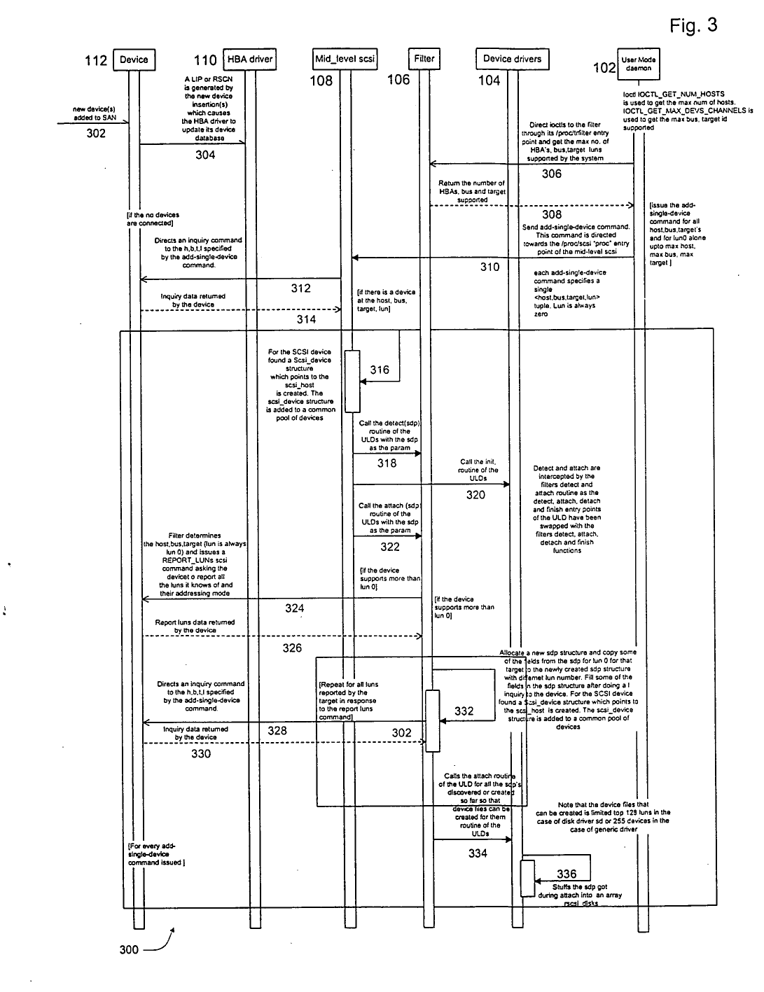

FIG. 3 is a sequence diagram according to unified modeling language (UML) principles illustrating a method and arrangement of dynamically detecting multiple SCSI devices on a Linux host in accordance with an exemplary embodiment of the invention.

Sequence 300 in FIG. 3 depicts the various interactions between a user mode daemon 102, device drivers 104 (e.g., ULDs sd, st, sr, sg), a filter driver 106, a mid-level SCSI driver 108, an HBA driver 110, and a device (e.g., SCSI device) 112 of a SCSI Subsystem. Device 112 may represent one or a plurality of SCSI devices, more particularly one or more logical units (represented by their LUNs) on a SCSI target device (target).

In FIG. 3, addition of new SCSI devices 112 to the SCSI subsystem is shown as message 302. In an embodiment, these devices 112 are to be added to a SAN (not shown) and must be identified by a Linux host on the SAN. Unlike the current Linux implementation, these devices are to be dynamically (e.g., in real time) added to SAN. In other words, a re-boot of the Linux host running the Linux OS is not required.

When a SCSI device 112 is being added to a network such as to a SAN, the device 112 generates (304) what is called a Loop Initialization Primitive sequence (LIP). This breaks a loop, called a fibre channel arbitrated loop (FC-AL), after which the loop requires re-synchronization. The generated LIP is detected by the HBA driver 110, must be able to detect the LIP and add any new devices which have been added to the SAN to a known list (e.g., device database). In other words, HBA driver 110 needs to update its device database in order to re-synchronize the loop. In a Fabric topology (e.g., fibre channel (FC environment on a SAN), which involves the presence of switch, insertion or removal of a device 112 may generate a RSCN (resource state change notification) to the HBA driver 110, which requires the HBA driver 110 to identify the added/removed device 112.

In accordance with the method and arrangement of the present invention, the SCSI Subsystem, and hence the Linux host, supports a rescan mechanism for the underlying Linux OS in order to dynamically detect devices 112 being added to or removed from the SAN. The rescan is preferably triggered periodically in order to gets updated lists of devices from the HBA driver 110. This may be done from user space, where a user mode daemon will periodically initiate a rescan of the SCSI buses by issuing the add-single-device command from user mode.

The user-mode daemon initially direct input output control commands (IOCTLS) 306. The IOCTLs may includes commands to return the actual number of hosts (HBAs) that are currently present in the Linux system (e.g., IOCTL_GET_NUM_HOSTS) and to return the maximum number of buses (SCSI buses), targets (SCSI target devices) supported by the SCSI subsystem.

The IOCTLs 306 are directed to a filter driver 106 that is inserted in the SCSI Subsystem of the Linux host. The filter driver 106, which is an upper level driver (ULD) that supports the user/kernel interface, will create a /proc entry point for itself so that it may receive IOCTLs from user mode daemon 102. In other words, it creates a point of communication between the user mode space and the kernel mode space for the user mode daemon 102 to send commands across to the kernel space. As will be seen below, the filter driver 106 will end up taking over functions of the device drivers 108, (e.g., ULDs such as sd, sr, st, sg) so that the filter driver 106 can assist in providing dynamic (real time) detection of devices 112 on the Linux host.

Filter driver 106 returns (308) the number of HBAs that are present in the system, max buses and targets that are supported, by the Linux host to the user mode daemon 102, User mode daemon 102 then issues an IOCTL (105) to mid-level SCSI driver 108 that contains the add-single-device command, which is issued for all hosts present in the Linux system, max buses and targets supported by the Linux system and for lun(0). This is a performance optimization of the user mode rescan algorithm discussed earlier, but in this embodiment the algorithm is not iterating for all the adapters that could be present in system. Instead the algorithm iterates only for adapters that are currently present in the system. Moreover the add-single-device command is called only for lun(0) on the target device. So the algorithm for scan in the user mode daemon becomes the following:

For all SCSI host bus adapters, from scsi0 through scsiN (adapters present
in the system)

For all SCSI bus, from bus0 through bus255 on this host adapter

For all SCSI IDs on this bus, (e.g., id0 through id255 on this
bus)

For Lun(0)

Do add-single-device

End Lun-Loop

End-Target Loop

End-Bus Loop

End-Adapter Loop

Accordingly, each add-single-device command specifies a single (h,b,t,l) tuple (e.g., grouping) where the LUN specified is always lun(0). The “add-single-device” command is not called for LUN values other than 0 unless a particular target supports sparse luns. Devices which support sparse luns are those where the lun numbers are not sequential in nature. The luns can be numbered 1,3,7,9 and there could be holes in between

In FIG. 3, the following are performed for every add-single-device command issued by user mode daemon 102, as indicated by a box 311. Mid-level SCSI driver 108 directs a SCSI inquiry command (312) to the particular h,b,t,lun(0) path specified by the add-single-device command, to determine if there is actually a SCSI device 112 at the particular h,b,t,lun(0) path. The responding lun(0) returns inquiry page payload to the mid-level SCSI driver 108. This payload may include fields of identifying data such as data related to vendor identification, product identification, product revision level of the logical unit (e.g., a “discovered” logical unit of a SCSI device 112).

The retrieved identifier information is used by the mid-level SCSI driver 108 to create (316) a scsi₁₃ device_structure (SDP) for the device 112, which holds the h, b, t, l values in addition to other values. The SDP for each lun(0) is added to a common pool of SCSI devices 112 that are known by the Linux host.

Additionally, and using the just created SDP as a parameter in the call, for each discovered device 112, mid-level SCSI driver 108 makes a procedure call 107 for a detect ( ) entry routine to see what ULDs might be willing to drive (e.g. to “claim”) the device 112. Normally this call for a detect ( ) routine will go to all device drivers 104 (sd, st, sr, sg). However, in this embodiment, the call 107 for the detect ( ) entry routine goes directly to filter driver 106, which has been inserted between mid-level SCSI driver 108 and device drivers 104 to intercept call 107. This is because the filter driver 106 has swapped its entry points with the entry points of all device drivers 104.

In Linux, each device driver type (sd, sr, st, sg) of the device drivers 104 registers a scsi_device_template with the OS kernel (not shown). The SCSI subsystem uses the scsi_device _templates to call various SCSI type driver routines (detect( ), init( ), finish( ), attach( ), detach( ) etc.) for each type of SCSI device 112. By swapping its own driver routine entry points with the device drivers' 104 routines (i.e., swapping detect( ), attach( ), detach( ), finish( ) entry points of the disk, tape, generic device drivers with its own), the filter driver 106 may be called by the midlevel SCSI driver 108 and has control over all LUNs of a discovered device 112 (which previously would have been under the control of the device derivers 104.)

Specifically, the filter driver 106 looks where these entry points are stored in device drivers 104, saves a copy for itself, and then overwrites them with its own detect( ) entry point. That way, the filter can do additional processing before calling the entry points of the upper layer drivers (device drivers 104) if one or more wants to control a particular LUN. So a difference between the present invention and the standard Linux implementation is that instead of the ULDs (device drivers' 104) detect( ) point being called directly at 318, the filter driver 106's detect( ) point is called first, and then the filter driver 106 calls an upper-layer driver's (108) detect( ) routine. In particular, any call for a detect ( ), attach( ), detach( ) or finish( ) routine will be intercepted by filter driver 106.

Additionally as part of the detect( ) routine, the filter driver 106 increases the size of the vector rscsi_disks array. As discussed above, in the standard Linux implementation, the size of the array was fixed at the number of devices noticed during boot time, plus a small limited number of spare entries for newly added devices (for example, any hot-plugged) device. By increasing the size of the vector rscsi_disks array, more “slots” are thereby created for any additional (newly discovered) hot-plugged devices. Accordingly, a much larger number of devices can be added or deleted dynamically (“on the fly”) by increasing the spare entries for new devices held in the SCSI subsystem.

Next, an init( ) entry point routine is called (320) for all ULDs (device drivers 104) for initialization; this will allocate internal data structures (mainly arrays indexed by minor number). This is not intercepted by filter driver 106 because this entry point has not been swapped.

But, as an attach( ) entry point routine is called (322) to insert the created SDP into the internal tables of a ULD, the filter driver 106 intercepts, so that the SDP is “copied into its internal tables, vice device drivers 104. The attach( ) routine of the filter discovers LUNs other than lun(0) on the target device. In order to avoid sending SCSI commands to a target from 0 to MAX_LUN, (for all 255 LUNs of a target) the filter driver 106 instead passes a REPORT_LUNS SCSI command (324) to the device at that (h, b, t, l(0)).

In other words, filter driver 106 does not scan for LUNs, but rather uses REPORT_LUNS to obtain all the LUNs behind a target. This command 324 requests a list of all the LUNs supported by that target. From the response to REPORT_LUNs command (326) the filter driver 106 ascertains the number of LUNs on that specific target device. The filter driver 106 then creates as many scsi_device structures as there are LUNs on the target device (332). It copies most of fields from the scsi_device structure of LUN 0 to the newly created scsi_device structures. The lun number needs to be updated in all the newly created scsi_device structures; and some of the fields in the newly created device structure are filled up with actual inquiry data (330) (identifier data unique to that LUN). One such field may be a queue depth field. For all LUNs reported in return 328, the following steps 328, 330, 332 are performed, as evident by box 327. Filter driver 106 sends an INQUIRY command (328) to each logical unit (device 112) reported by REPORT_LUN SCSI command response. The inquiry data is used to fill up information in the SDPs, which are dynamic in nature. The resultant “new SDP” is added to the common pool of devices. Thus, by dynamically creating scsi_device structures to represent all the LUNs being discovered (other than for LUN 0) for a target, the filter driver 106 is able to provide a dynamic device detection capability.

As discussed above, since the filter driver 106 has been inserted and has swapped entry points, it has been intercepting entry points that are normally intended for the device drivers 108. The filter driver 106 now calls (334) attach( ) routines of the ULDs (e.g., device drivers 104) for all the newly created or discovered SDPs up to this point, so that device files can be created for the SDPs. For example, if the SCSI subsystem wishes to attach a new SCSI disk device, it will call the SCSI disk type attach routine. This will allow the disk driver to insert the “new” SDP, into its internal table of SDPs. The index into this table becomes the minor number of the device file which points to the device 112. The device files are created by a known user mode MAKEDEV utility during system initialization time, which enables the user mode daemon 102 to talk to a device 112 (e.g., logical unit) using the device file created by the MAKEDEV utility.

When the attach( ) routine is called, each device driver 104 “stuffs” (336) corresponding SDPs for the new devices into the vector rscsi_disks array, which had already been expanded by the filter driver 106, thereby creating more “slots” for the devices that were newly discovered in this particular rescan.

Therefore, the method and arrangement of the invention may be used to enable a Linux host to dynamically (in real time) detect newly added devices, By dynamically creating scsi_device structures to represent LUNs being discovered for a target (other than for LUN 0) on the fly. The use of the filter driver 106 makes it possible to send any SCSI command to any device on the SAN (even for numbers of newly added disk devices greater than the 128 disk device limitation of the disk driver, or greater than the 256 generic device limitation of the generic driver) discussed as part of patent application so and so. This cannot be done in standard Linux. The method and arrangement eliminate the querying of all LUNs (255) of a target, as currently done, since the only LUNs (other than lun(0), that are queried are LUNs that are actually present, as evident by the response to the REPORT_LUNS command.

The invention having been thus described the invention may be varied in many ways. For example, the method and apparatus of the present invention may be implemented in storage area networks (SANs) that use a Fibre Channel (FC) medium for the underlying network transport and, at the upper driver layer, move data to and from disks with serial SCSI protocol, as described in the current draft SCSI Primary Commands-3 (SPC-3) document.

Additionally, FIGS. 2 and 3 may be implemented in hardware and/or software. The hardware/software implementation may include a combination of processors, application service providers, application specific integrated circuits (ASICs) and/or articles of manufacture. The articles of manufacture may further include storage media and executable computer program. The executable computer program may include the instructions to perform the described operations. For example, the computer program may be a product that includes a computer-readable medium having computer program logic stored thereon for enabling a processor of the product to dynamically detect multiple SCSI devices being added to a Linux host. The computer executable programs may also be provided as part of externally supplied propagated signals. Such variations are not to be regarded as a departure from the spirit and scope of the invention, and all such modifications as would be obvious to one skilled in the art are intended to be included within the scope of the following claims.

What is claimed:

1. A method of dynamically detecting SCSI devices on a Linux host, comprising:
issuing a first command to return an actual number of hosts that are currently installed in a Linux system, and a maximum number of buses and targets supported by the Linux system;
issuing a second command to all hosts, buses and targets returned in response to the first command, but only to a logical unit number zero (lun(0)) of each returned target, the second command prompting each responding lun(0) to report all luns known to the target; and
creating a new device structure in real time for each reported lun, each new device structure representing a detected SCSI device.

2. The method of claim 1, further comprising:
generating a device structure for each responding lun(0), wherein said creating step further comprises copying a portion of each generated lun(0) device structure into a new device structure of every reported lun.

3. The method of claim 1, further comprising:
creating device files for all new device structures, wherein the created device files enable a user to communicate with detected SCSI devices.

4. The method of claim 3, wherein said creating devices files step further comprises invoking a MAKEDEV utility to create the device files.

5. An arrangement for dynamically detecting SCSI devices on a Linux host, comprising:
means for issuing a first command to return an actual number of hosts that are currently installed in a Linux system, and a maximum number of buses and targets supported by the Linux system;
means for issuing a second command to all hosts, buses and targets returned in response to the first command, but only to lun(0) of each returned target, the second command prompting each responding lun (0) to report all lun(x)'s known to the target; and
means for creating a new device structure in real time for each reported lun, each new device structure representing a detected SCSI device.

6. The arrangement of claim 5, wherein said means for creating a new device file generates a device structure for each responding lun(0), and copies a portion of each generated lun(0) device structure into a new device structure of every reported lun.

7. The arrangement of claim 5, further comprising:
means for creating device files for all new device structures, wherein the created device files enable a user to communicate with detected SCSI devices.

8. The arrangement of claim 7, wherein said means for creating device files invokes a MAKEDEV utility to create the device files.

9. A method, for use in a storage network, enabling a kernel component of a Linux system supporting the storage network to dynamically detect one or more SCSI devices, so that a user application accessing the storage network may communicate with the SCSI devices, comprising:
the user application
issuing a first command to the kernel component to return an actual number of hosts that are currently installed in a Linux system, and a maximum number of buses and targets supported by the Linux system; and
issuing a second command to all hosts, buses and targets returned in response to the first command, but only to a logical unit number zero (lun(0)) of each returned target, the second command prompting each responding lun (0) to report all luns known to the target; and
the kernel component
creating a new device structure in real time for each reported lun, each new device structure representing a detected SCSI device.

10. The method of claim 9, the kernel component further generating a device structure for each responding lun(0), and copying a portion of each generated lun(0) device structure into a new device structure of every lun(x) the lun(0) reported.

11. The method of claim 9, the user application further directing creation of device files for the new device structures, wherein the created device files enable the user application to communicate with detected SCSI devices.

12. The method of claim 11, the user application invoking a MAKEDEV utility to create the device files.

13. The method of claim 9, further comprising inserting the kernel component into a SCSI I/O subsystem of the Linux system.
